(19) United States
(12) Patent Application Publication
(10) Pub. No.: US 2024/0376560 A1
(43) Pub. Date: Nov. 14, 2024

(54) METALLURGICAL MELTING FURNACE, AND METHOD FOR DETERMINING THE AMOUNT OF HETEROMOLECULAR GAS

(71) Applicant: PROMECON Process Measurement Control GmbH, Barleben (DE)

(72) Inventors: Hans Georg CONRADS, Hannover (DE); Matthias MÄDE, Eichenbarleben (DE)

(21) Appl. No.: 18/689,268

(22) PCT Filed: Sep. 7, 2022
(86) PCT No.: PCT/DE2022/000097

§ 371 Date: Mar. 5, 2024

(30) Foreign Application Priority Data
Sep. 10, 2021 (DE) 10 2021 004 593.9

(51) Int. Cl. C21C 5/46

(52) U.S. Cl. CPC C21C 5/4673

(57) ABSTRACT

A metallurgical melting furnace having a furnace vessel, an offgas removal device disposed therein for removal of an offgas stream, and an air feed opening for feeding air to the offgas stream, provides a method of determining the amount of heteromolecular gas and a method of determining the temperature of the gas.

The invention relates to a metallurgical melting furnace having a furnace vessel, an offgas removal device disposed therein for removal of an offgas stream, and an air feed opening for feeding air to the offgas stream, and to a method of determining the amount of heteromolecular gas and to a method of determining the temperature of the gas.

In the operation of metallurgical melting furnaces, various gases, often including harmful gases, are formed owing to the processes that proceed therein. In order to optimize the processes that proceed within the metallurgical melting furnace and to reduce the proportion of harmful gases, exact knowledge of the gases formed, especially also in terms of their ratio to one another, is an essential prerequisite for efficient control of the individual process parameters. A significant barrier for many methods of measurement is the extremely high temperatures that occur during the processes, which are in the region of above 1000° C.

The prior art discloses various approaches by which it would be possible to determine the proportion of gas molecules in the metallurgical melting furnace.

DE 10 2008 009 923 A1 discloses a method of determining combustible offgas constituents within an arc furnace by means of optical sensors. In order to measure the local CO concentration, optical fibers are arranged such that the light in the region beneath the individual oxygen injectors is detected optically. The amount of the offgas constituents is then evaluated and used for closed-loop control of the supply of oxygen to the arc furnace. The advantage here is that the heterogeneous distribution within the arc furnace is detected separately, and the individual oxygen injectors can be controlled separately. However, optical fibers in the furnace can lead to major problems because of the high temperatures. In particular, spectroscopic methods using a laser are utilized here, which makes such a measurement setup very complex and hence costly to configure.

EP 1 776 576 B1 describes contactless offgas measurement by FTIR spectroscopy in metallurgical assemblies. An FTIR spectrometer is disposed in the vicinity of a converter, the measurement beam from which is directed into the offgas at a suitable opening in the offgas duct. The spectra found with the FTIR spectrometer, with involvement of the offgas temperature and a mathematical model, are used to calculate the offgas composition without time delay. A disadvantage is that this method too is very complex and maintenance-intensive.

DE 28 57 795 C2 discloses a radiation detector for a flame sensor, having a sensor element and a spectral filter disposed in front of it, which is transparent in the region of carbon dioxide resonance radiation.

DE 195 09 704 A1 discloses a method and an arrangement for monitoring and control of combustion processes. Radiation measurements in oil burners or gas burners are utilized, with detection of two different spectral regions of a flame by a sensor arrangement. The selectively amplified signals are utilized by means of algorithms for closed-loop control and monitoring of the combustion process. Such a method does evaluate the radiation emitted by the flames in a controlled combustion process, which is an indication of the type of reaction taking place. However, no direct measurement of the amount of gases or of the gas composition is possible by this method.

A further means of monitoring flames is described in U.S. Pat. No. 3,903,014, which can especially be employed in the control of processes for steel melting. Here too, no direct measurement of the amounts of gas is conducted.

U.S. Pat. No. 2,009,102 103 A1 describes a method which detects radiation within an industrial furnace by means of a spectrometer and an infrared sensor. For this purpose, the spectroscopic device is disposed at a window opening which also ensures supply of air into the offgas. However, the use of a spectrometer is disadvantageously complex and costly.

DE 10 2006 005 823 A1 discloses a method of closed-loop control of a burner-fired furnace. This involves detecting one component of a gas stream, where at least a portion of the radiation emitted by the gas stream is detected. Rather than merely a single spectral line being evaluated here, the emissions of the component are detected over a relatively wide subregion of the spectrum. There is thus broadband recording of the spectrum emitted. The emissions detected at the different wavelengths are used to form a cumulative signal, which is differentiated twice with respect to time. The progression of the signal thus found against time gives qualitative information about the proportion of the component in the gas stream. For instance, qualitative statements may be made as to the amount of the component being sought. A disadvantage here is that calibration by a conventional measurement is required in order to be able to make a quantitative statement. Only by means of such a calibration is it possible by this method to determine absolute amounts of the components of the gas stream. Moreover, it is complicated to set up such a measurement in a furnace vessel of a metallurgical melting furnace.

In the method described in in DE 42 31 777 A1 too, emission spectra of flames or offgases therefrom are evaluated. However, mounting of such sensors in a metallurgical melting furnace harbors a number of problems.

A significant problem with the apparatuses and methods according to the prior art is the very high temperature that occurs in the melting furnace, which is the reason why the mounting of measuring instruments in the furnace vessel is very complicated and laborious. Frequently, absorption measurements using lasers are utilized, which are very complex and hence costly. What would thus be desirable would be an uncomplicated means of measurement in a metallurgical melting furnace that gives exact knowledge of the gas constituents generated during the process.

It is thus an object of the invention to provide a simple and inexpensive means of determining the absolute concentration of the gas generated in a metallurgical melting furnace.

Absolute concentration in the context of the invention is understood to mean the number of heteromolecular gas molecules per unit volume, i.e., for example, per cubic centimeter.

The object is achieved by an article having the features according to the independent claims. Developments are specified in the dependent claims.

The object is especially achieved by a metallurgical melting furnace, having a furnace vessel for melting of metal with an offgas removal device disposed therein for removal of an offgas stream. An air feed opening is formed therein for feeding fresh air to the offgas stream. According to the invention, the offgas removal device has at least one measurement opening beyond the air feed opening, and a photodiode having a spectral filter for separation of the electromagnetic radiation of a specific wavelength range is formed in a spaced-apart arrangement at the measurement opening outside the offgas removal device such that electromagnetic radiation which is generated within the offgas removal device and escapes through the measurement opening is detectable at least in part by the photodiode. This exploits the fact that the molecules have typical energy levels and electrons from these molecules emit photons in the event of a change of state. Changes in state for the purposes of the invention are changes in the energy levels of the electrons, which emit photons, i.e. electromagnetic radiation, in the event of a transition from a higher energy level to a lower energy level.

Electromagnetic radiation of a specific wavelength range in the context of the invention is the electromagnetic radiation having wavelengths within a particular defined range. This range is usually defined by one or more spectral filter(s). The specific wavelength range corresponds to a characteristic progression of the spectral filter, with different degrees of transmission of different wavelengths by the spectral filter depending on the characteristics of the spectral filter.

The spectral filter is disposed between the photodiode and the measurement opening and filters the electromagnetic radiation before it hits the photodiode. As a result, only the electromagnetic radiation of the specific wavelength range, according to the characteristic of the spectral filter, reaches the photodiode and is detected.

The spectral filter preferably has a molecule-specific transmission characteristic.

The offgas removal device here may be tubular.

What is meant by “beyond the air feed opening” in the context of the invention is beyond the air feed opening in flow direction of the offgas stream. What is meant more particularly here by “beyond the air feed opening” is that the measurement opening, viewed from the air feed opening, is disposed on the side remote from the furnace vessel.

The air feed opening preferably takes the form of an air feed ring.

Such an arrangement of the measurement opening and of the photodiode spaced apart therefrom beyond the air feed opening is remarkable in that the incoming air leads to a change in the composition of the gas mixture in the offgas removal device. Further CO₂ and O₂ flows in here through the air feed opening and alters the amount of CO₂ or CO or other heteromolecular gases, for example H₂O, CH₄, NOₓ, SOₓ, in the offgas removal device, since the oxygen in the incoming air results in reactions with the heteromolecular molecules in the hot offgas. Surprisingly, the measurement device for determination of the absolute concentration at the offgas removal device may nevertheless be disposed beyond the air feed opening, even though further CO₂ and O₂ flows in through the air feed opening and there is a change in the amount of CO₂ and CO or of another heteromolecular gas in the offgas removal device. The reason for this is that, firstly, the incoming air has such a low temperature that the number of photons emitted by these molecules is small enough not to affect the measurement, and that, secondly, the post-combustion of CO to CO₂ or a reaction with another heteromolecular gas proceeds only in the course of mixing of the incoming air with the offgas stream. The further reaction in which CO reacts to give CO₂, and the other reactive processes that proceed, take place essentially only later on, i.e. downstream of the measurement opening in flow direction of the offgas stream. As a result, the hot gas stream can be analyzed through the cold inflow of air. The cold inflow of air surrounds the hot gas or offgas in the manner of a gas curtain, and the transition states of the hot gas or offgas are above the detection threshold and determinable because of the high temperatures. As a result, it is advantageously possible to ascertain the gas composition of the hot gas at a site exposed to temperatures that are less high as a result of the distance from the furnace vessel and the inflow of air. Especially in the case of the preferred design of the air feed opening in the form of a ring, the interruption of the offgas removal device leads to a certain thermal separation and a mechanical separation of the offgas removal device, and is thus particularly suitable.

The measurement opening, in a suitable embodiment, is closed by means of a transparent material, preferably in the form of a protective glass.

In an advantageous variant, at least two measurement openings having at least two photodiodes in a spaced-apart arrangement are disposed in the offgas removal device. In fact there are preferably three or four measurement openings having at least three or four photodiodes disposed in the offgas removal device. It is alternatively also possible for there to be two or more photodiodes in a spaced-apart arrangement at a measurement opening. What is relevant here is that any measurement openings with photodiodes spaced apart therefrom are disposed beyond the feed opening. Preferably, each photodiode has a different spectral filter, such that different wavelength ranges are detectable by means of the individual photodiodes.

Each photodiode is disposed in the line of sight of the electromagnetic radiation passing through the measurement opening.

A measurement channel preferably runs from the measurement opening to the photodiode. The measurement channel here is not transparent and hence protects the measurement from adverse outside influences, for example disruptive radiation. The measurement channel is thus formed between the measurement opening and the photodiode.

In an advantageous configuration of the metallurgical melting furnace, it has a heating device for melting of the metal in the melt bath. There are preferably two or more electrically operated electrodes for generation of arcs disposed in the heating device. Such a metallurgical melting furnace is also referred to as an arc furnace.

The electrical signals generated by the photodiode are preferably amplified by a measurement amplifier in the photodiode. In an advantageous configuration, both the spectral filter and the photodiode and the measurement amplifier are disposed within a housing.

Preferably, either the photodiode or the measurement amplifier is connected to an evaluation unit for processing of the electrical signal generated. Because of the electromagnetic radiation generated by the photodiode, the evaluation unit can then ascertain the amount of individual gas components.

In order to be able to ascertain the absolute concentration of heteromolecular gas in hot gases, i.e. the proportion of heteromolecular gas, the fact that a hot gas with a given temperature T and given pressure in the region of standard pressure, i.e. with variances of +/−10%, contains thermally excited heteromolecular molecules that emit photons is exploited. The necessary temperature here is T >400 K, in order that the number of photons emitted reaches a level from which the photodiode can detect photons.

The calculation of the density and of the molecular separation in the gas mixture at a given temperature is preferably effected via the ideal gas equation, and it is possible to ascertain the number of excited molecules in conjunction with the information relating to the geometry of the components, i.e. here in particular the geometry of the offgas removal device and the installation conditions of the measurement openings and of the photodiode.

The photodiode is preferably designed for detection in the infrared region, for example made from InAsSb. Alternative materials are InSb, InAs, PbS or PbSe. The exact characteristic of the photodiode, especially also the temperature-dependent characteristics thereof, and physical and electronic properties of the photodiode and the exact area of the photodiode are used in the evaluation.

For differentiated detection of the gas constituents, in one possible variant, one spectral filter is used per desired molecule, or alternatively a combination of multiple spectral filters with defined spectral regions.

Such a filter or such a combination of two or more filters is referred to as a molecule-specific filter. These molecule-specific spectral filters are used in order to be able to ascertain a selection of the photons from infrared bands, which are also referred to as IR bands, of the desired heteromolecular molecule. IR bands in the context of the invention are typical spectral progressions of the emitted electromagnetic radiation with identical maxima, which may take different forms in a molecule-specific manner. The IR bands can be used to ascertain the wavelength of the molecule-specific maxima and the typical intensity ratio thereof. Exact knowledge of the characteristic of the spectral filter is needed here as a basis for the quantum-mechanical and statistical evaluation. The characteristic can then be used to determine what IR transition contributes to the measurement to what degree. This is done by analyzing a suitable molecule-specific section from the overall IR band.

The object is also achieved by a method of determining heteromolecular gas formed in a metallurgical melting furnace by means of a metallurgical melting furnace of the invention with an evaluation unit, comprising the following steps:
a) passing the gas including a proportion of heteromolecular gas through an offgas removal device,
b) feeding air at low temperature to the offgas stream,
c) detecting the electromagnetic radiation of a specific wavelength range that has been emitted by the gas by means of the photodiode,
d) determining the proportion of heteromolecular gas by means of the evaluation unit.

The transition rate, i.e. the number of photons that are emitted per molecule, with knowledge of the temperature, leads to a characteristic emission spectrum for each molecule. With regard to the geometry of the metallurgical melting furnace of the invention, and taking account of the characteristics of the spectral filters and photodiodes on the properties of the measurement amplifier, it is possible to create a concentration characteristic for different molecule concentrations. It is possible with preference to store different concentration characteristics in the evaluation unit, such that the output current of the measurement amplifier gives information about the concentration of the gas for a particular configuration of the metallurgical melting furnace. For a known temperature, it is possible to use this to directly ascertain the amount of emitting molecules, i.e. the absolute concentration of the molecules.

The object is also achieved by a method of determining the amount of heteromolecular gas formed in a metallurgical melting furnace by means of an apparatus of the invention with an evaluation unit, comprising the following steps:
a) passing the gas including a proportion of heteromolecular gas through an offgas removal device,
b) feeding air at low temperature to the offgas stream,
c) detecting the electromagnetic radiation of a specific wavelength that has been emitted by the gas by means of the photodiode with a spectral filter,
d) determining the temperature and passing the temperature onward to the evaluation unit,
d) determining the amount of heteromolecular gas by means of the evaluation unit.

The spectral filter through which the radiation emitted is filtered is preferably a molecule-specific filter.

A further aspect of the invention relates to a method of determining the temperature of a gas containing at least a portion of a heteromolecular gas by means of an apparatus of the invention having at least two photodiodes and at least two different spectral filters, comprising the following steps:
a) passing the gas including a proportion of heteromolecular gas through an offgas removal device,
b) feeding air at low temperature to the offgas stream,
b) detecting the electromagnetic radiation of at least two specific wavelengths or two IR bands that has been emitted by the gas by means of the photodiode,
c) determining the temperature of the gas by matching with temperature-dependent emission characteristics of the gas.

The basis of the principle of evaluation here is that, for any given molecule, the IR band, i.e. the number and the wavelength of photons emitted by the transition states for a specific molecule, depends solely on the temperature. It is thus possible after an evaluation of the IR band, i.e. when the molecule composition is known, to conclude how many photons are being emitted by a molecule at a given temperature. If the two IR bands found, i.e. the levels of the two photodiode currents, are expressed relative to one another, what is obtained is a characteristic that depends solely on the gas temperature and is independent of the concentration of that molecule and the geometry of the metallurgical melting furnace, and also the arrangement of the measurement openings and the photodiodes. The determination of the temperature of the gas in step d) by matching with temperature-dependent emission characteristics of the gas thus preferably first includes the step of determining the proportion of heteromolecular gas by means of the evaluation unit.

In order to determine the intensity of the electromagnetic radiation in two different wavelength regions, two filter-photodiode combinations are used. The geometry of the spectral filters and diodes is of relevance only when they are different. In the case of two identical spectral filter-photodiode combinations, there is no need to take note of this; otherwise, this can be taken into account and corrected by calculation.

The two spectral filters must cover different spectral regions, although an overlap is possible. It should be ensured that there is a sufficient concentration of the type of molecule of which the spectrum is being utilized, such that detection is possible. The measurement must be conducted below the saturation region of the temperature characteristic. For unambiguous determination of temperature, a monotonous characteristic is required. This should be taken into account in the selection of the molecule being evaluated. Very narrowband filtering, i.e. using a filter that transmits only a very small wavelength range, ensures a very minor influence by other molecules on the measurement results. The spectral filter preferably has a transmission range, i.e. a range in which the radiation is transmitted to an extent of at least 50%, preferably at least 70%, more preferably at least 85%, which has a width of not more than 10 μm, preferably not more than 9 μm, more preferably not more than 4 μm. In an advantageous variant of the method, wavelengths or wavelength regions in which there is essentially one type of molecule emitting, i.e. having a maximum, are evaluated.

In one possible execution, two spectral regions are considered, by means of which mutual correction is possible. In one variant, moreover, a gas temperature ascertained by an alternative method is used for control and/or correction.

A spectral filter preferably has layers of dielectric materials, preferably selected from the group of the oxides, for example titanium dioxide (TiO₂), hafnium dioxide (HfO₂), tantalum pentoxide (Ta₂O₅), silicon dioxide (SiO₂), yttrium oxide (Y₂O₃), and/or the fluorides, for example manganese fluoride (MgF₂) or variant fluoride (BaF₂) or YF₃, and/or the sulfides, for example zinc sulfide (ZnS), and/or the selenides, for example zinc selenide (ZnSe). The layer thicknesses are chosen such that defined transmission properties can be achieved on the basis of constructive and destructive interference.

In one possible configuration, the spectral filter(s) take(s) the form of semiconductor filters. These act as absorption filters, especially for electromagnetic radiation below a particular wavelength, which is regarded as the absorption edge. Because of the bandgap, electromagnetic radiation can be transmitted in a high proportion above the absorption edge.

Semiconductor filters have long wavelength transmission properties and consist of coated, optically polished semiconductor wafers that are frequently mounted in holders for protection. Because of their very high absorption in the barrier region, they are particularly useful in IR grid monochromators, i.e. spectral filters for transmission within a small range of infrared radiation, in order to eliminate higher-order spectra. It is particularly advantageous to use semiconductor filters since the higher-order spectra, i.e. at lower wavelength and high energy, are particularly disruptive when high-temperature sources are used.

In an advantageous configuration, a spectral filter, especially a spectral filter made of dielectric materials or a semiconductor filter, has an antireflection coating on one side, preferably the radiation input side, which faces the incident electromagnetic radiation, or on the radiation input side and on the radiation output side, i.e. that which faces the photodiode. This increases the transmission of the electromagnetic radiation which is to pass through the spectral filter. It is advantageously thus possible to achieve improvements of up 60% compared to spectral filters without such an antireflection coating. In the case that the spectral filter is disposed upstream of a photodiode, up to 60% more radiation of the relevant wavelength will reach the photodiode and can then be detected thereby.

The spectral filters are preferably at least partly transparent in at least one subregion of the infrared spectrum. The antireflection coatings of such a spectral filter preferably have a transmittance of at least 20%, preferably at least 30%, more preferably at least 50%, for wavelength ranges of 3 to 12 μm, preferably for 3-5 μm or for 5 to 8 μm or for 8 to 12 μm.

The antireflection coatings preferably take the form of a single layer or of a multilayer coating. A single layer has the advantage here of being manufacturable in a simple and inexpensive manner.

A multilayer coating in turn can advantageously be optimized and adapted for multiple angles of incidence and for multiple wavelength ranges. A preferred substrate material for a multilayer coating is germanium. It is advantageously thus possible to achieve transmission rates in individual wavelength ranges of more than 95%.

Preferred substrate materials for an antireflection layer which is formed from a single layer are germanium, silicon, sapphire, zinc selenide or gallium arsenide.

The spectral filters preferably take the form of narrow bandpass filters. Only narrow wavelength regions are transmitted, with a maximum of 6%, preferably a maximum of 5%, of a peak value at which transmission is thus at its maximum. Attenuation values outside the transmission region are high, such that transmission for radiation outside the region is not more than 10%, preferably not more than 1%, more preferably not more than 0.1%.

In one possible execution, two spectral regions are considered, by means of which mutual correction is possible. In one variant, moreover, a gas temperature ascertained by an alternative method is used for control and/or correction.

It is preferable to take account of the transition levels within the spectral range defined by the filter that lead to a temperature characteristic, such that the geometry of the metallurgical melting furnace is irrelevant. A particularly preferred variant of the method first envisages ascertaining the temperature and then determining the concentration with reference to the temperature.

The characteristics recorded can advantageously be ascertained theoretically, such that there is no need for calibration or recalibration.

Further details, features and advantages of configurations of the invention will be apparent from the description of working examples that follows, with reference to the accompanying drawings. The figures show:

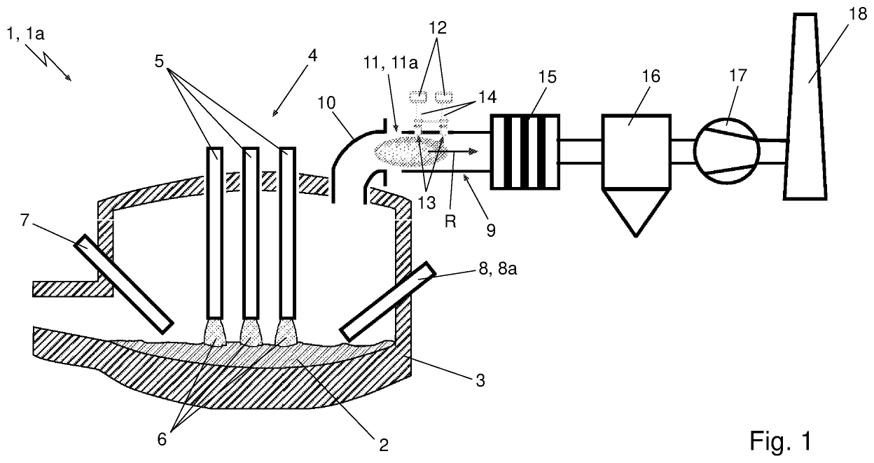

FIG. 1: an arc furnace,

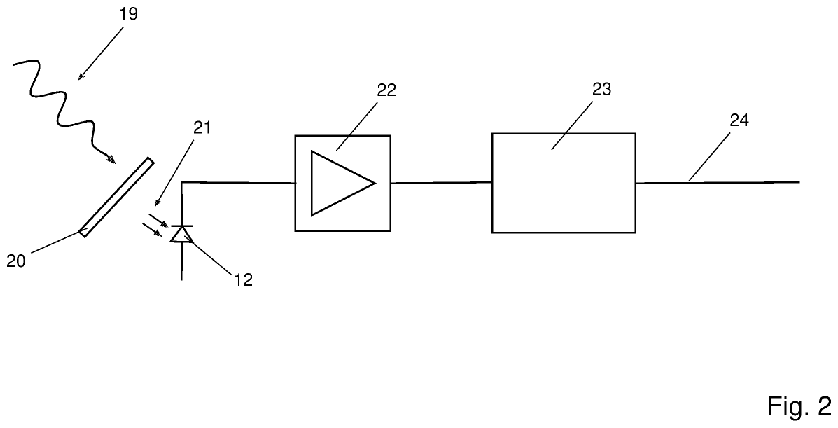

FIG. 2: a diagram of a measurement setup and

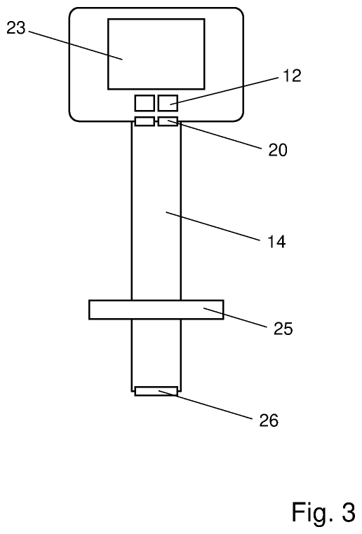

FIG. 3: a diagram of a measurement device with a photodiode.

FIG. 1 shows a metallurgical melting furnace 1 in the form of an arc furnace 1a for melting of metal. The metal melt bath 2 is disposed within a furnace vessel 3. A heating device 4 that projects into the furnace vessel 3 has three electrodes designed for feeding with three-phase AC current. The heat generated by the electrical energy from the arc furnace 6 is used to melt the metal in the melt bath 2. Also disposed in the furnace vessel 3 are a gas burner 7 and an oxygen supply element 8 in the form of an oxygen probe 8a.

The offgases produced in the furnace vessel 3 are directed by an offgas opening into an offgas removal device 9. Between the furnace vessel 3 and the offgas removal device 9 are disposed an offgas manifold 10 and an air feed opening 11 in the form of an air feed ring 11a. Air at a low temperature flows through the air feed opening 11 into the offgas removal device 9. The air feed opening 11 is disposed between the furnace vessel 3 and the offgas removal device 9. Further combustion takes place in the offgas removal device 9, especially with involvement of reactions of the incoming oxygen.

Also disposed near the offgas removal device 9, spaced apart from the offgas removal device 9, are two photodiodes 12 beyond the air feed opening 11 in offgas flow direction. In order to be able to detect electromagnetic radiation from the interior of the offgas removal device 9, there exist two measurement openings 13 in the offgas removal device 9 through which the electromagnetic radiation can enter a measurement channel 14 and then reach the photodiodes 12. Measurement openings 13 may be closed by a material transparent to the relevant electromagnetic radiation. This prevents escape of the offgases flowing within the offgas removal device 9.

Further down the offgas removal device 9, downstream of the air feed opening 11, is disposed a cooler 15 for cooling the offgas stream and a filter 16 for separation of solid particles out of the offgas. The offgas is subsequently directed through the induced draft fan 17 and into the chimney 18.

FIG. 2 shows a diagram of a measurement setup for use in the offgas removal device 9 of a metallurgical melting furnace 1, especially an arc furnace 1a. The electromagnetic radiation of all wavelengths 19 arise here at a spectral filter 20, such that, beyond the spectral filter 20, only electromagnetic radiation of a specific wavelength range 21 is passed onward to the photodiode 12. The electrical signal which is then generated by the photodiode 12 is amplified by means of a measurement amplifier 22 and then processed by an evaluation unit 23. The output values from the measurement output 24 can then be utilized to optimize the closed-loop control of the arc furnace (not shown here).

A diagram of a measurement device with at least one photodiode 12 and a measurement channel 14 is shown in FIG. 3. The measurement device is secured by means of a mounting flange 25 on the outside of the offgas removal device (not shown here). The photodiode 12 is disposed with the spectral filter 20 directly adjoining the measurement channel 14.

Between the measurement channels 14 and the interior of the offgas removal device 9 are disposed measurement openings (not shown here) in the wall of the offgas removal device 9, in order to allow the electromagnetic radiation from the interior of the offgas removal device 9 to pass through the measurement channel 14 in the direction of the photodiodes 12. At the end of the measurement channel 14, which, in the installed state, points in the direction of the offgas removal device is disposed a transparent protective glass 26. Through this protective glass 26, also referred to as protective window 26, the electromagnetic radiation generated within the offgas removal device can enter the measurement channel 14, with simultaneous prevention of penetration of offgases into the measurement channel 14.

### LIST OF REFERENCE NUMERALS

1 Metallurgical melting furnace
1a Arc furnace
2 Metal melting bath, melting bath
3 Furnace vessel
4 Heating device
5 Electrode, heating device
6 Arc
7 Gas burner
8 Oxygen feed element
8a Oxygen probe
9 Offgas removal device
10 Offgas manifold
11 Air feed opening
11a Air feed ring
12 Photodiode
13 Measurement opening
14 Measurement channel, sleeve tube
15 Cooler
16 Filter
17 Induced draft fan
18 Chimney
19 Electromagnetic radiation of all wavelengths
20 Spectral filter
21 Electromagnetic radiation of a specific wavelength range
22 Measurement amplifier
23 Evaluation unit
24 Measurement output
25 Mounting flange
26 Protective glass, protective window
R Offgas flow direction

1. A metallurgical melting furnace, having a furnace vessel for melting of metal, the furnace vessel having an offgas removal device disposed therein for removal of an offgas stream, where an air feed opening for feeding fresh air to the offgas stream is formed in the offgas removal device, wherein the offgas removal device has at least one measurement opening beyond the air feed opening, and a photodiode having a spectral filter for separation of the electromagnetic radiation of a specific wavelength range is formed in a spaced-apart arrangement at the measurement opening outside the offgas removal device such that electromagnetic radiation which is generated within the offgas removal device and escapes through the measurement opening is detectable at least in part by the photodiode.

2. The metallurgical melting furnace as claimed in claim 1, wherein the melting furnace has a heating device for melting of the metal in the melt bath.

3. The metallurgical melting furnace as claimed in claim 1, wherein the melting furnace has a heating device having two or more electrically operated electrodes for generation of arcs.

4. The metallurgical melting furnace as claimed in claim 1, wherein the measurement opening is closed by means of a transparent material.

5. The metallurgical melting furnace as claimed in claim 1, wherein the photodiode is disposed in the line of sight of the electromagnetic radiation passing through the measurement opening.

6. The metallurgical melting furnace as claimed in claim 1, wherein electrical signals generated by the photodiode are amplified by a measurement amplifier in the photodiode.

7. The metallurgical melting furnace as claimed in claim 1, wherein at least two measurement openings having at least two photodiodes in a spaced-apart arrangement are disposed in the offgas removal device.

8. The metallurgical melting furnace as claimed in claim 6, wherein the photodiode or the measurement amplifier is connected to an evaluation unit for processing of the electrical signals generated.

9. A method of determining heteromolecular gas formed in a metallurgical melting furnace, the method comprising:
a) passing an offgas stream including a proportion of heteromolecular gas through an offgas removal device in the metallurgical melting furnace;
b) feeding air at low temperature to the offgas stream;
c) detecting, by means of a photodiode in the offgas removal device, electromagnetic radiation of a specific wavelength range that has been emitted by the offgas stream; and
d) determining the proportion of heteromolecular gas by means of an evaluation unit connected to the photodiode and configured to process electrical signals generated by the photodiode.

10. A method of determining a temperature of a gas containing a hetero-molecular gas by means of a metallurgical melting furnace, the method comprising:
a) passing an offgas stream including a proportion of heteromolecular gas through an offgas removal device in the metallurgical melting furnace;
b) feeding air at low temperature to the offgas stream;
c) detecting, by means of at least two photodiodes in the offgas removal device and at least two different spectral filters, electromagnetic radiation of at least two specific wavelength ranges emitted by the offgas stream; and
d) determining the temperature of the gas by matching the detected electromagnetic radiation with temperature-dependent emission characteristics of the gas.
